(19) United States
(12) Patent Application Publication
(10) Pub. No.: US 2012/0313967 A1
(43) Pub. Date: Dec. 13, 2012

(54) METHOD AND APPARATUS FOR ENHANCING THE DISPLAY OF AN ELECTRONIC READING DEVICE

(75) Inventor: Timothy Youngjin Sohn, Mountain View, CA (US)

(73) Assignee: Nokia Corporation, Espoo (FI)

(21) Appl. No.: 13/156,094

(22) Filed: Jun. 8, 2011

(51) Int. Cl. G09G 5/00

(52) U.S. Cl. 345/629

(57) ABSTRACT

Provided herein is a technique by which the display of an electronic reading device may be enhanced. An image of a first page may be displayed at a predefined contrast and an image of a second page may be displayed at less than the predefined contrast in an underlying relationship to the image of the first page. The first page and the second page may be consecutive pages in a page order. The page order may mimic a page order of a print copy. In response to the second page being a facing page to the first page in the print copy, the image of the second page may appear forward facing. In response to the second page appearing on the opposite side of the first page in the print copy, the image of the second page may be presented as a mirror image of the second page.

### TECHNOLOGICAL FIELD

Some example embodiments of the present invention relate generally to apparatuses configured to provide for display of an image and, more particularly, to apparatuses configured to present images resembling printed pages.

### BACKGROUND

The modern communications era has brought about a tremendous expansion of wireline and wireless networks. Computer networks, television networks, and telephony networks are experiencing an unprecedented technological expansion fueled by consumer demands. Together with these expanding network capabilities and communication speeds, the devices that use these networks have experienced tremendous technological steps forward in capabilities, features, and user interface technology. Devices communicating via these networks may be used for a wide variety of purposes including, among other things, presentation of images of pages of books, magazines, newspapers, or other printed or published materials, Short Messaging Services (SMS), Instant Messaging (IM) service, E-mail, voice calls, music recording/playback, video recording/playback, and internet browsing. Such capabilities have made these devices very desirable for those wishing to stay in touch and make themselves available to others.

Electronic reading devices, or “E-readers” have become popular devices by which a user may view an image of a page presented as a printed page would be seen in a book, magazine, or newspaper. E-readers mimic the presentation of printed materials to provide the user a more nostalgic or familiar medium in which books, magazines, or newspapers may be read. While E-readers provide a familiar medium mimicking printed materials, E-readers suffer from several drawbacks that distinguish the images generated by an E-reader from the printed pages of a published work. It may therefore be desirable to provide images of printed materials in a manner that more closely mimics the native format of the printed materials.

### BRIEF SUMMARY

A method, apparatus and computer program product are provided to enable an apparatus, such as an electronic reading device, to more closely mimic the presentation of printed pages of a publication. As such, the user experience for the user of an electronic reading device may be enhanced with the operation of the electronic reading device seeming more realistic and intuitive.

An example embodiment may provide a method including causing an image of a first page to be displayed with a predefined contrast, and causing an image of a second page to be displayed with the second page caused to be displayed in an underlying relationship relative to the image of the first page and with less than the predefined contrast. The first page and the second page may be consecutive pages in a page order. The page order may mimic a page order of a print copy. The image of the second page may be caused to be displayed so as to be forward facing. In response to the second page appearing on the opposite side of the first page in the print copy, the image of the second page may be caused to be displayed as a mirror image of the second page. The image of the second page may contain a graphical representation that is at least partially visible in the underlying relationship relative to the image of the first page. An example embodiment may further include causing the image of the first page to cease to be displayed in response to a command to advance a page, causing the image of the second page to be displayed so as to have the predefined contrast, and causing an image of a third page, to be displayed with less than the predefined contrast and in an underlying relationship to the image of the second page.

Another example embodiment may provide an apparatus including at least one processor and at least one memory including computer program code, the at least one memory and the computer program code configured to, with the processor, cause the apparatus to at least cause an image of a first page to be displayed with a predefined contrast, and cause an image of a second page to be displayed with the second page caused to be displayed in an underlying relationship relative to the image of the first page and with less than the predefined contrast. The first page and the second page may be consecutive pages in a page order. The page order may mimic a page order of a print copy. In response to the second page being a facing page to the first page in the print copy, the image of the second page may be caused to be displayed so as to be forward facing. The image of the second page may be caused to be displayed so as to be a mirror image of the second page. The image of the second page may contain a graphical representation that is at least partially visible in the underlying relationship relative to the image of the first page. The apparatus may further be configured to be cause the image of the first page to cease to be displayed in response to a command to advance a page, cause the image of the second page to be displayed with the predefined contrast, and cause an image of a third page to be displayed with less than the predefined contrast and in an underlying relationship to the image of the second page.

Another example embodiment may provide a computer program product comprising at least one non-transitory computer-readable storage medium having computer-executable program code instructions stored therein, the computer-executable program code instructions comprising program code instructions to cause an image of a first page to be displayed with a predefined contrast, and cause an image of a second page to be displayed in an underlying relationship relative to the image of the first page and with less than the predefined contrast. The first page and the second page may be consecutive pages in a page order. The page order may mimic a page order of a print copy. In response to the second page being a facing page to the first page in the print copy, the image of the second page may be caused to be displayed so as to be forward facing. The image of the second page may be caused to be displayed so as to be a mirror image of the second page. The computer program product may further be configured with program code instructions to cause the image of the first page to cease to be displayed in response to a command to advance a page, cause the image of the second page to be displayed with the predefined contrast, and cause an image of a third page to be displayed with less than the predefined contrast and in an underlying relationship to the image of the second page.

Another example embodiment may provide an apparatus including means for causing an image of a first page to be displayed with a predefined contrast, and means for causing an image of a second page to be displayed in an underlying relationship relative to the image of the first page and with less than the predefined contrast. The first page and the second page may be consecutive pages in a page order. The page order may mimic a page order of a print copy. In response to the second page being a facing page to the first page in the print copy, the image of the second page may be caused to be displayed so as to be forward facing. The image of the second page may be caused to be displayed so as to be a mirror image of the second page. The image of the second page may contain a graphical representation that is at least partially visible in the underlying relationship relative to the image of the first page. The apparatus may further be configured with means for causing the image of the first page to cease to be displayed in response to a command to advance a page, means for causing the image of the second page to be displayed with the predefined contrast, and means for causing an image of a third page to be displayed with less than the predefined contrast and in an underlying relationship to the image of the second page.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of an apparatus for enhancing the display of an electronic reading device according to an example embodiment of the present invention;

FIG. 2 is an illustration of an electronic reading device according to an example embodiment of the present invention;

FIG. 3 is an illustration of an electronic reading device according to another example embodiment of the present invention;

FIG. 4 is an illustration of a print copy of a book;

FIG. 5 is an illustration of an electronic reading device according to an example embodiment of the present invention;

FIG. 6 is an illustration of an electronic reading device according to another example embodiment of the present invention; and

FIG. 7 is a flowchart diagram according to an example method for enhancing the display of an electronic reading device according to an embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with some embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein a “computer-readable storage medium,” which refers to a non-transitory, physical storage medium (e.g., volatile or non-volatile memory device), can be differentiated from a “computer-readable transmission medium,” which refers to an electromagnetic signal.

Some embodiments of the present invention may provide for enhancements in the display of pages on an electronic reading device. Electronic reading devices, as described herein, may include apparatuses that provide for presentation of images that resemble the printed pages of a book, magazine, newspaper, or other publication. As such, users may be able to interact with electronic reading devices in a more intuitive manner.

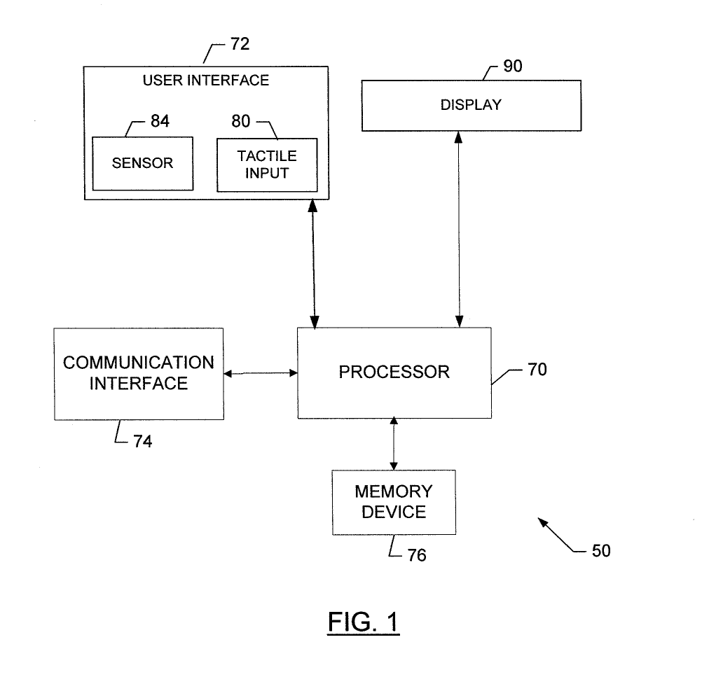

An example embodiment of the invention will now be described with reference to FIG. 1, in which certain elements of an apparatus 50 for causing images of pages, such as pages of a printed publication or the like, to be presented or displayed. The apparatus 50 of FIG. 1 may be employed, for example, as an electronic reading device or as a portion or component of an electronic reading device. FIG. 1 illustrates a block diagram of an apparatus 50 that would benefit from embodiments of the present invention. It should be understood, however, that the apparatus 50 as illustrated and hereinafter described is merely illustrative of one type of device that may benefit from embodiments of the present invention and, therefore, should not be taken to limit the scope of embodiments of the present invention. As such, although numerous types of apparatuses, such as electronic reading devices, portable digital assistants (PDAs), mobile telephones, pagers, mobile televisions, gaming devices, laptop computers, cameras, tablet computers, touch surfaces, wearable devices, video recorders, audio/video players, radios, positioning devices (e.g., global positioning system (GPS) devices), or any combination of the aforementioned, and other types of devices configured for the display of images may readily employ embodiments of the present invention, other devices including both mobile and fixed (non-mobile) electronic devices may also employ some example embodiments.

It should also be noted that while FIG. 1 illustrates one example of a configuration of an apparatus, such as an electronic reading device, for causing an image of a page to be displayed numerous other configurations may also be used to implement embodiments of the present invention. As such, in some embodiments, although devices or elements are shown as being in communication with each other, hereinafter such devices or elements should be considered to be capable of being embodied within a same device or element and thus, devices or elements shown in communication should be understood to alternatively be portions of the same device or element.

Referring again to FIG. 1, an apparatus 50 for causing images of pages to be presented is provided and may include or otherwise be in communication with a processor 70, a user interface 72, a communication interface 74 and a memory device 76. In some embodiments, the processor 70 (and/or co-processors or any other processing circuitry assisting or otherwise associated with the processor 70) may be in communication with the memory device 76 via a bus for passing information among components of the apparatus 50. The memory device 76 may include, for example, one or more volatile and/or non-volatile memories. In other words, for example, the memory device 76 may be an electronic storage device (e.g., a computer readable storage medium) comprising gates configured to store data (e.g., bits) that may be retrievable by a machine (e.g., a computing device like the processor 70). The memory device 76 may be configured to store information, data, applications, instructions or the like for enabling the apparatus to carry out various functions in accordance with an example embodiment of the present invention. For example, the memory device 76 could be configured to buffer input data for processing by the processor 70. Additionally or alternatively, the memory device 76 could be configured to store instructions for execution by the processor 70.

The apparatus 50 may, in some embodiments, be a device or be embodied in a device capable of presenting an image on a display such as an electronic reading device or other display device. However, in some embodiments, the apparatus 50 or at least a portion thereof including the processor 70 may be embodied as a chip or chipset. In other words, the apparatus 50 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 50 may therefore, in some cases, be configured to implement an embodiment of the present invention on a single chip or as a single “system on a chip.” As such, in some cases, a chip or chipset may constitute means for performing one or more operations for providing the functionalities described herein.

The processor 70 may be embodied in a number of different ways. For example, the processor 70 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 70 may include one or more processing cores configured to perform independently. A multi-core processor may enable multiprocessing within a single physical package. Additionally or alternatively, the processor 70 may include one or more processors configured in tandem via the bus to enable independent execution of instructions, pipelining and/or multithreading.

In an example embodiment, the processor 70 may be configured to execute instructions stored in the memory device 76 or otherwise accessible to the processor 70. Alternatively or additionally, the processor 70 may be configured to execute hard coded functionality. As such, whether configured by hardware or software methods, or by a combination thereof, the processor 70 may represent an entity (e.g., physically embodied in circuitry) capable of performing operations according to an embodiment of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and/or operations described herein when the instructions are executed. However, in some cases, the processor 70 may be a processor of a specific device (e.g., an apparatus configured to provide for display of an image, such as an electronic reading device) adapted for employing an embodiment of the present invention by further configuration of the processor 70 by instructions for performing the algorithms and/or operations described herein. The processor 70 may include, among other things, a clock, an arithmetic logic unit (ALU) and logic gates configured to support operation of the processor 70.

Meanwhile, the communication interface 74 may be any means such as a device or circuitry embodied in either hardware or a combination of hardware and software that is configured to receive and/or transmit data from/to a network and/or any other device or module in communication with the apparatus 50. In this regard, the communication interface 74 may include, for example, an antenna (or multiple antennas) and supporting hardware and/or software for enabling communications with a wireless communication network. In some environments, the communication interface 74 may alternatively or also support wired communication. As such, for example, the communication interface 74 may include a communication modem and/or other hardware/software for supporting communication via cable, digital subscriber line (DSL), universal serial bus (USB) or other mechanisms.

The user interface 72 may be in communication with the processor 70 to receive an indication of a user input at the user interface 72 and/or to provide an audible, visual, mechanical or other output to the user. As such, the user interface 72 may include, for example, a sensor, button, touch areas, device surfaces capable of detecting objects hovering over the surface, soft keys, a microphone, a speaker, motion sensor, temperature sensor, accelerometer, or other input/output mechanisms. In this regard, for example, the processor 70 may comprise user interface circuitry configured to control at least some functions of one or more elements of the user interface, such as, for example, a speaker, ringer, microphone, display, and/or the like. The processor 70 and/or user interface circuitry comprising the processor 70 may be configured to control one or more functions of one or more elements of the user interface through computer program instructions (e.g., software and/or firmware) stored on a memory accessible to the processor 70 (e.g., memory device 76, and/or the like).

In an example embodiment, the apparatus 50 may include or otherwise be in communication with a display 90. In different example cases, the display 90 may be a two dimensional (2D) or three dimensional (3D) display and may include multiple display surfaces. The user interface 72 may be in communication with the display 90 to receive indications of user inputs and to modify a response to such inputs based on corresponding user actions that may be inferred or otherwise determined responsive to the indications. In one alternative, an input may be provided other than by direct interaction with a tactile input (e.g., tactile input 80), such as a movement of the entire or part of the apparatus 50 which may be interpreted by a sensor 84, such as an accelerometer.

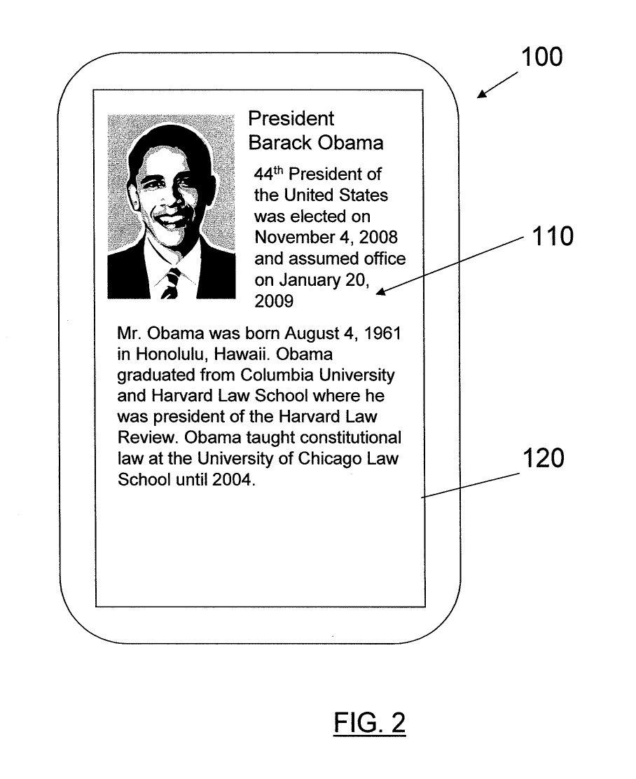

As such, example embodiments may provide for an apparatus (e.g., the processor 70 or a chipset including the processor 70) for providing display of an image of a page of a printed publication or the like. As noted above, the apparatus may comprise or be embodied in an electronic reading device 100. Electronic reading devices 100 may provide a visual depiction of page that resembles the printed page of a book, magazine, newspaper, or other printed publication, as shown in FIG. 2. The illustrated embodiment depicts an electronic reading device 100 that is presenting an image of a page 110 on the display 120. The image of the page 110 may appear as it would in a print copy of a book or other publication. While the depicted image 110 may resemble a printed page of a book, the image may be depicted in such a manner regardless of whether a printed version of the page or publication to which the page belongs has ever been produced in print form. Said otherwise, an image of a page may be presented as it would appear in print form despite the page only being produced in an electronic format.

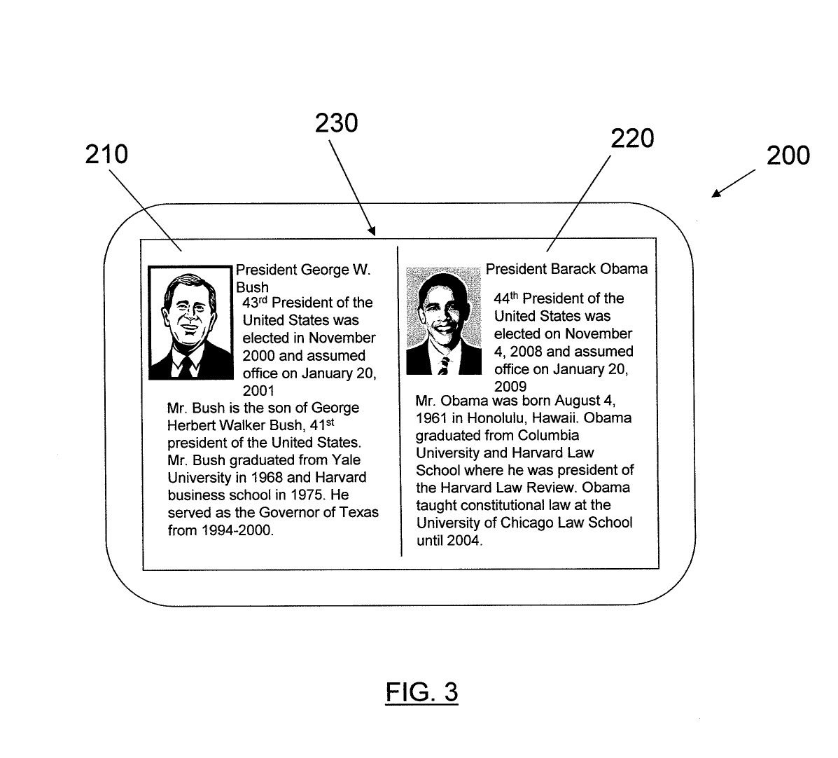

One common characteristic of some electronic reading devices 100 is that only a single page 110 is represented on the display 120. The ability of a user to read the page 110 and simultaneously reference another page, such as in reference to a figure, table, or other feature, is precluded by the display of only a single page as in FIG. 2. To at least partially address this issue, FIG. 3 illustrates another embodiment of an electronic reading device 200 which depicts two pages 210, 220 on the display 230 simultaneously. The depiction of two pages simultaneously may more closely replicate the facing pages of physical book or other publication; however, in order to display the pages 210, 220 in a large enough size for a user to comfortably read them, the display 230 of the electronic reading device 200 may be required to be of a size that hinders the portability of the electronic reading device. Conversely, if the display of the electronic reading device 200 is limited in size so as to be more conveniently portable, the images of the pages 210, 220 may be too small to be easily read by a user.

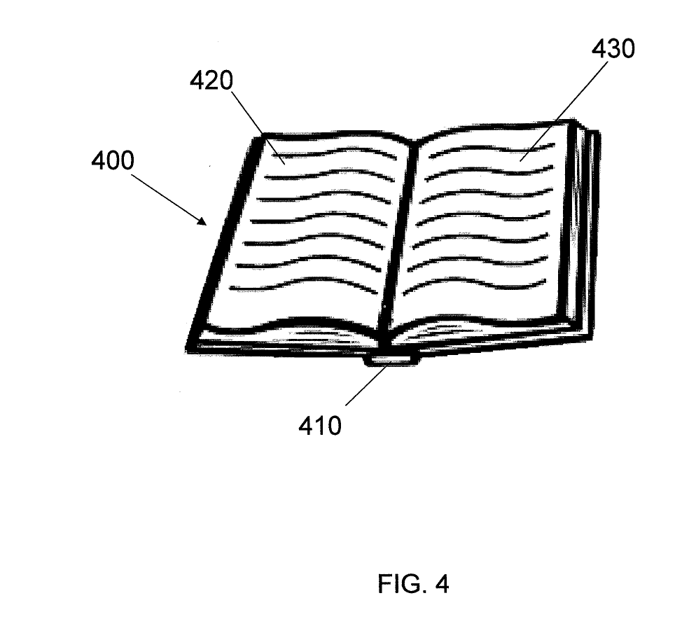

Pages of publications such as books and magazines may be bound or otherwise attached along a spine such that when the publication is opened, there are pages on the left and right of a centerline defined by the binding or spine. FIG. 4 illustrates a typical bound book 400 including a spine 410, a left page 420, and a right page 430. The right page 430 is a facing page to page 420 and vice versa. When reading the left page 420 of the book 400, the information on the facing page 430 is readily visible to a reader such that any reference on the left page 420 to the information on the right page 430 may be quickly reviewed by a reader glancing between the pages. However, such substantially simultaneous viewing of facing pages of a book is not possible when a user is viewing a single page displayed by an electronic reading device, such as of the type shown in FIG. 2. In order for a user of an electronic reading device that is configured to display a single page at a time to view information on any other pages, the user must switch between pages. At any one time, however, the user in this example is only able to view a single page. This switching between pages may be inconvenient and may slow the reading and comprehension of information, particularly if pages on the electronic reading device are slow to render or process, making the page changing/turning process slow. As such, it may be desirable for a user to be able to reference information on a facing page without requiring the user to change the page on the electronic reading device, even in an instance in which the electronic reading device displays only one page at a time.

With reference again to FIG. 4, when a reader is reading the right page 430 of a book 400, the reader may be able to see images, figures, or other details of the next page due to the translucency of the pages of the book or publication. While generally not particularly clear, the reader's ability to see aspects of the next page may be helpful. For example, a user may be able to view an upcoming page break, chapter break, picture, graphic, or other information that a reader may find useful while reading the right page 430.

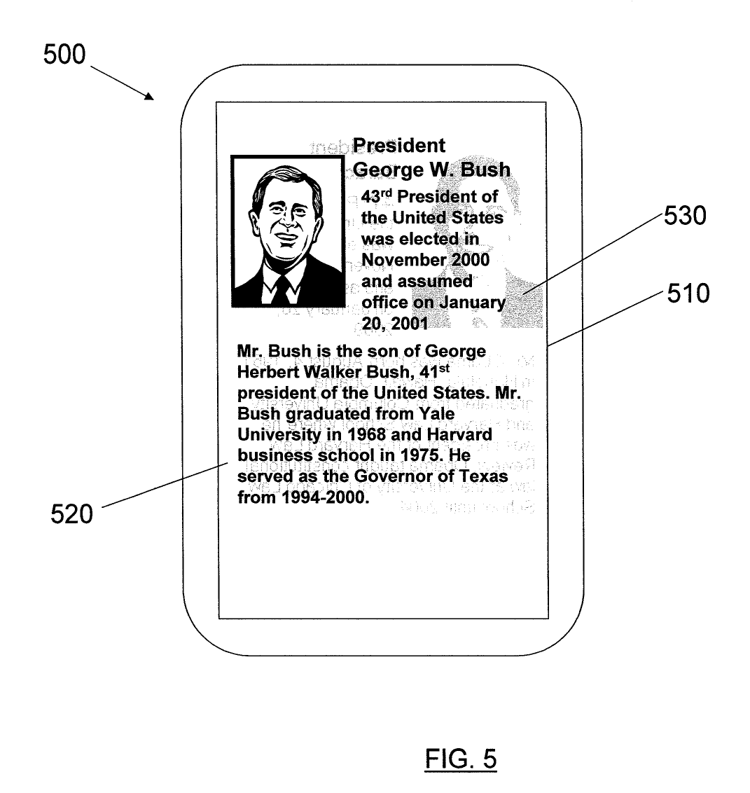

Example embodiments of the present invention therefore provide an apparatus, method and computer program product that are configured to allow a user who is viewing an image of a first page to simultaneously view an image of a second page in the same field of view as the first page while not obscuring the image of the first page. FIG. 5 depicts an electronic reading device 500 including a display 510. The display 510 is configured to present an image of a first page 520 at a predefined contrast, such as in full or substantially full contrast. The image of the first page 520 is depicted such that it can be easily read by a user and easily discerned from the background depicted on the display 510. An image of a second page 530 is also depicted in less than the predefined contrast, such as less than full contrast. The image of the second page 530 is presented in an underlying relationship to the image of the first page 520. The image of the second page 530 therefore appears “behind” the image of the first page 520 as the image of the first page 520 is not at all obscured by the image of the second page 530. However, the image of the second page 530 is obscured by the image of the first page 520, thereby creating the appearance that the image of the second page 530 is behind the image of the first page 520.

The term “contrast” is used herein to define the visibility of an image. The term contrast as used herein may therefore reference the brightness of an image displayed such that “full contrast” indicates that the image is depicted with the colors appearing in normal, full brightness as they would when viewed on a printed page. In other words, full contrast indicates that the image is depicted as clearly as possible, subject to limitations of the electronic reading device and its display. Full contrast provides a clear distinction between the light and dark portions of the image, such as between the text elements and the whitespace between the text elements. Less-than-full contrast may include a lower level of brightness, less contrast between light and dark portions of the image, and/or lower pixel density. As used herein, contrast may reference any characteristic of an image which may be varied to make the image more or less visible.

The image of the second page 530 is an illustration of another page of the book, magazine, or other publication that is being viewed by a user of the electronic reading device 500. In practice, the second page may be the next page in a page order of the publication. The pages may be consecutive such that the second page is the page after the first page when the publication is read.

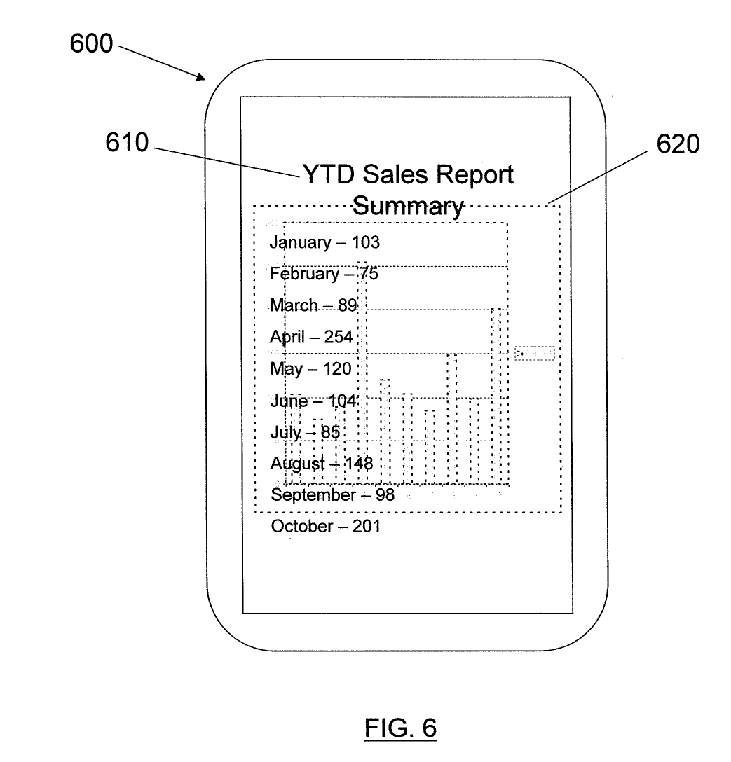

FIG. 6 is another illustration of an image of a first page 610 presented at a predefined contrast, such as at substantially full contrast, while an image of a second page 620 is presented at less than the predefined contrast, such as less than full contrast. The image of the second page is presented so as to appear in an underlying relationship, such as being behind the image of the first page 610. In the depicted embodiment, the image of the first page 610 is numerical sales data. Numerical data may not be as easily discerned or comprehended by many readers such that a graphical representation of the sales numbers may be considerably more beneficial. The image of the second page 620, which is visible in less than the predefined contrast behind the image of the first page 610, depicts a graphical representation of the sales figures of the first page. A user of the electronic reading device 600 may readily see that the graphical information is presented on the following page such that they understand that if they advance to the next page (e.g., the second page) the user will see the sales figures presented graphically.

When viewing a publication in print form, as illustrated in FIG. 4, the information on the facing page (e.g., page 430) is visible in a forward-facing view. However, when viewing the right page 430 of the publication, the information on the next page, which is printed on the back of page 430, is visible in a mirror-image view. The apparatus, method and computer program products of example embodiments of the present invention may be configured to present an image of a second page, such as the next page, in less than the predefined contrast in either a forward-facing view or a mirror-image view. The presentation of the image of the second page may be dependent upon whether or not the second page is a facing page in a print-version of the publication or a page printed on the back of the first page, such as the current page in the print version of the publication. For example, the image of the second page may be a forward-facing view in an instance in which the second page is a facing page in the print-version of the publication, while the image of the second page may be a mirror-image view in an instance in which the second page is printed on the back of the first page in the print-version of the publication. Optionally, a user may be able to select that images of a second page are presented in a forward-facing view or a mirror image view regardless of the relationship of the first and second pages in the print version of the publication. In an instance in which the image of the second page is presented as a forward-facing view even though the print version of the second page is presented on the opposite side, e.g., back, of the first page, the reading experience provided by the electronic reading deice may deviate from the reading experience of a printed publication; however, the forward-facing view of the next page may be more easily understood by a user of the electronic reading device.

In one embodiment, an image of the second page may only be presented behind the currently displayed image of the first page if the second page contains information that is able to be discerned by a user. For example, if the second page includes a page break, a chapter break, a graphic, or other predetermined distinguishing elements, then an image of the second page may be presented in less than the predefined contrast behind the image of the currently displayed first page. Alternatively, if the second page contains only text and no predetermined distinguishing elements, an image of the second page may not be presented behind the image of the currently displayed first page.

Another example embodiment of the present invention may include an electronic reading device configured to concurrently display images of multiple pages with the same predefined contrast, such as in full contrast, as shown, for example in FIG. 3. The electronic reading device 200 may present images of a left page 210 and a right page 220. The electronic reading device 200 may further present an image of the page prior to the left page 210 behind the image of the left page 210 in less than the predefined contrast. The electronic reading device 200 may further present an image of the page subsequent to the right page 220 behind the image of the right page 220 in less than the predefined contrast. Thus, a user could see information regarding the left and right pages before and after the pages that are prominently displayed on the device 200.

Conventionally electronic reading device are configured to permit a user to advance a page (or recount a previous page) by the press of a button or other possible input. When advancing a page, the image of the first page with the predefined contrast is replaced by an image of the second page, also with the predefined contrast. The apparatus of one example embodiment of the present invention may provide an enhanced mechanism by which the pages are advanced. In this regard, when an image of a first page is presented in full contrast and an image of a second, subsequent page is presented in less than full contrast, a user may indicate or provide an input that indicates that the page is to be advanced. In response to receiving the input, the apparatus may cause the image of the first page to cease to be displayed while causing the image of the second page to be presented in the predefined contrast, such as in full contrast. Further, the apparatus of this embodiment may cause an image of a third page to be presented in less than the predefined contrast behind the image of the second page. Each of the first, second, and third page may be consecutive pages in a page order of the print version of the publication.

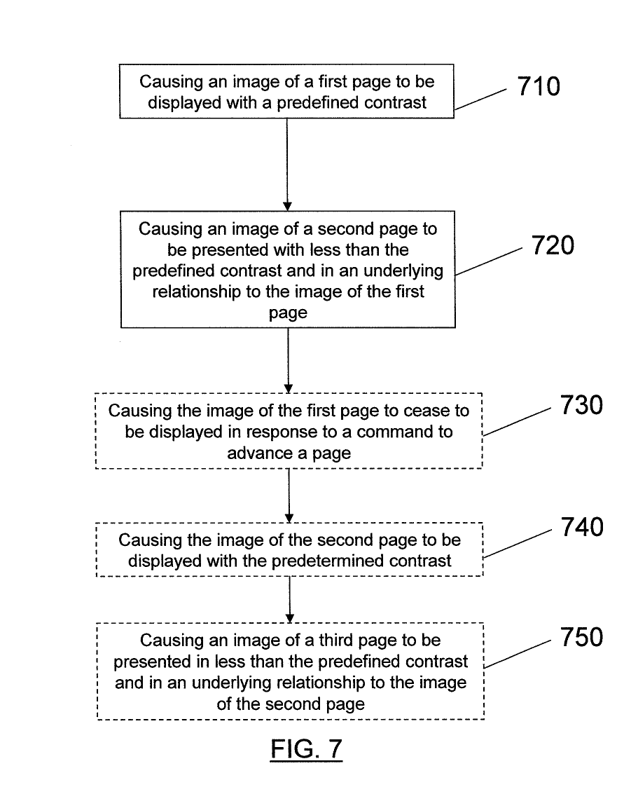

FIG. 7 is a flowchart of a technique according to example embodiments of the invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device (e.g., memory 76) of a user device such as apparatus 50 and executed by a processor 70 in the user device. As will be appreciated, any such computer program instructions may be loaded onto a computer or other programmable apparatus (e.g., hardware) to produce a machine, such that the instructions which execute on the computer or other programmable apparatus create means for implementing the functions specified in the flowchart block(s). These computer program instructions may also be stored in a non-transitory computer-readable memory that may direct a computer or other programmable apparatus to function in a particular manner, such that the instructions stored in the computer-readable memory produce an article of manufacture which implements the functions specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In this regard, an apparatus according to one embodiment of the invention, as shown in FIG. 7, may include means, such as the processor 70, the display 90 or the like, for causing an image of a first page to be displayed with a predefined contrast, such as in full contrast, at 710. The apparatus may further include means, such as the processor 70, the display 90 or the like, for causing an image of a second page to be presented in an underlying relationship to the image of the first page so as to appear behind the image of the first page with the image of the second page being displayed at less than the predefined contrast, such as at less than full contrast, at 720.

In some embodiments, certain ones of the operations above may be modified or further amplified as described below. Moreover, in some embodiments additional optional operations may also be included, as depicted in the flowchart of FIG. 7 in broken lines. It should be appreciated that each of the modifications, optional additions or amplifications below may be included with the operations above either alone or in combination with any others among the features described herein. In some embodiments, the apparatus may include means, such as the processor 70, the display 90 or the like, for causing the image of the first page to cease to be displayed in response to a command to advance a page at 730. In this embodiment, the apparatus may include means, such as the processor 70, the display 90 or the like, for causing the image of the second page to be displayed with the predefined contrast, such as in full contrast, at 740. The apparatus of this embodiment may also include means, such as the processor 70, the display 90 or the like, for causing an image of a third page to be presented at less than the predefined contrast, such as at less than the full contrast, behind the image of the second page at 750. The first page and the second page may be consecutive pages in a page order and the page order may mimic the page order of a print copy of the publication. As described above, in an instance in which the image of the second page is displayed in an underlying relationship to the image of the first page, the image of the second page may be presented in a forward facing view, such as in response to the second page being a facing page in the print copy. Alternatively, the image of the second page may be presented in a mirror-image view, such as in response to the second page appearing on the opposite side, e.g., back, of the first page in the print copy.

As described above, an apparatus for performing the method of FIG. 7 above may comprise a processor (e.g., the processor 70) configured to perform some or each of the operations (710-750) described above. The processor 70 may, for example, be configured to perform the operations (710-750) by performing hardware implemented logical functions, executing stored instructions, or executing algorithms for performing each of the operations. Alternatively, the apparatus may comprise means for performing each of the operations described above. In this regard and as also described above, examples of means for performing operations 710-750 may comprise, for example, the processor 70, the display 90 or the like (or respective different components thereof).

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe some example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
causing an image of a first page to be displayed, wherein the image of the first page is caused to be displayed with a predefined contrast; and
causing, with a processor, an image of a second page to be displayed, wherein the second page is caused to be displayed in an underlying relationship relative to the image of the first page, and wherein the image of the second page is caused to be displayed with less than the predefined contrast.

2. The method of claim 1, wherein first page and the second page are consecutive pages in a page order.

3. The method of claim 2, wherein the page order mimics a page order of a print Copy.

4. The method of claim 3, wherein in response to the second page being a facing page to the first page in the print copy, the image of the second page is caused to be displayed so as to be forward facing.

5. The method of claim 1, wherein the image of the second page is caused to be displayed so as to be a mirror image of the second page.

6. The method of claim 1, wherein the image of the second page contains a graphical representation that is at least partially visible in the underlying relationship relative to the image of the first page.

7. The method of claim 1, further comprising:
causing the image of the first page to cease to be displayed in response to a command to advance a page;
causing the image of the second page to be displayed so as to have the predefined contrast; and
causing an image of a third page to be displayed, wherein the third page is caused to be displayed with less than the predefined contrast and in an underlying relationship to the image of the second page.

8. An apparatus comprising at least one processor and at least one memory including computer program code, the at least one memory and the computer program code configured to, with the processor, cause the apparatus to at least:
cause an image of a first page to be displayed, wherein the image of the first page is caused to be displayed with a predefined contrast; and
cause an image of a second page to be displayed, wherein the second page is caused to be displayed in an underlying relationship relative to the image of the first page, and wherein the image of the second page is caused to be displayed with less than the predefined contrast.

9. The apparatus of claim 8, wherein first page and the second page are consecutive pages in a page order.

10. The apparatus of claim 9, wherein the page order mimics a page order of a print copy.

11. The apparatus of claim 10, wherein in response to the second page being a facing page to the first page in the print copy, the image of the second page is caused to be displayed so as to be forward facing.

12. The apparatus of claim 8, wherein the image of the second page is caused to be displayed so as to be a mirror image of the second page.

13. The apparatus of claim 8, wherein the image of the second page contains a graphical representation that is at least partially visible in the underlying relationship relative to the image of the first page.

14. The apparatus of claim 8, the apparatus further configured to:
cause the image of the first page to cease to be displayed in response to a command to advance a page;
cause the image of the second page to be displayed so as to have the predefined contrast; and
cause an image of a third page to be displayed, wherein the third page is caused to be displayed with less than the predefined contrast in an underlying relationship to the image of the second page.

15. A computer program product comprising at least one non-transitory computer-readable storage medium having computer-executable program code instructions stored therein, the computer-executable program code instructions comprising program code instructions to:
cause an image of a first page to be displayed, wherein the image of the first page is caused to be displayed with a predefined contrast; and
cause an image of a second page to be displayed, wherein the second page is caused to be displayed in an underlying relationship relative to the image of the first page, and wherein the image of the second page is caused to be displayed with less than the predefined contrast.

16. The computer program product of claim 15, wherein first page and the second page are consecutive pages in a page order.

17. The computer program product of claim 16, wherein the page order mimics a page order of a print copy.

18. The computer program product of claim 17, wherein in response to the second page being a facing page to the first page in the print copy, the image of the second page is caused to be displayed so as to be forward facing.

19. The computer program product of claim 15, the image of the second page is caused to be displayed so as to be a mirror image of the second page.

20. The computer program product of claim 15, further comprising program code instructions to:
cause the image of the first page to cease to be displayed in response to a command to advance a page;
cause the image of the second page to be displayed so as to have the predefined contrast; and
cause an image of a third page to be displayed, wherein the third page is caused to be displayed with less than the predefined contrast an in an underlying relationship to the image of the second page.
